(19) United States
(12) Patent Application Publication
(10) Pub. No.: US 2020/0291225 A1
(43) Pub. Date: Sep. 17, 2020

(54) LOW COST BIO-BASED FULL DEGRADABLE FILM AND PREPARATION METHOD THEREOF

(71) Applicant: Jiangsu Golden-Poly Alloy Material Co.,Ltd., Danyang (CN)

(72) Inventors: Xiaojin Wu, Danyang (CN); Peng Si, Danyang (CN); Weiguo Wu, Danyang (CN); Weiming Weng, Danyang (CN); Zhigang Liu, Danyang (CN)

(21) Appl. No.: 16/851,056

(22) Filed: Apr. 16, 2020

Related U.S. Application Data
(63) Continuation of application No. PCT/CN2018/081023, filed on Mar. 29, 2018.

(30) Foreign Application Priority Data
Sep. 12, 2017 (CN) 201710816879.0

(51) Int. Cl. C08L 67/02; C08L 3/02; C08J 5/18; C08J 3/22

(52) U.S. Cl. CPC C08L 67/02; B29C 48/10; C08J 5/18; C08J 3/226; C08L 2203/16; C08L 2201/06; C08L 2205/035; C08L 2205/025; C08L 2205/06; C08L 2201/08; C08L 2205/08; C08L 2310/00; C08J 2367/02; C08J 2467/02; C08J 2303/02; C08J 2403/02; C08J 2467/04; C08J 2451/06; C08J 2423/08; C08J 2433/02; C08J 2429/14; C08L 3/02

(57) ABSTRACT

The present invention discloses a low cost bio-based full degradable film and preparation method thereof, the ratio of each component in parts by mass of the film is as follows: 15-25 parts of a polyglycolic acid, 25-35 parts of corn starch, 35-55 parts of poly(butylene adipate-co-terephthalate), 5 parts of a compatilizer, 3.75-12.25 parts of a starch plasticizer, 0.5-0.7 part of citric acid, 0.75-1.25 parts of acetyl tributyl citrate, 0.3-0.5 part of maleic anhydride, 0.2 part of antioxidant 164, and 0.2 part of 2-(2″-hydroxyl-5″-methylphenyl)benzotriazole. The low cost bio-based full degradable film provided by the present invention has a bio-based content, which can reach 30% or more, a lower cost, and a tensile strength exceeding a traditional PE thin film, and has very important significance for solving the problem of “white pollution” and promoting the popularization and application of full biodegradable materials.

### FIELD OF THE INVENTION

The invention is in the technical field of full biodegradable film. More specifically, the present invention relates to a low cost bio-based full degradable film and preparation method thereof.

### BACKGROUND OF THE INVENTION

The use of plastic packaging films has brought great convenience to our production and daily life. However, because the traditional plastic packaging films are made from non-degradable petroleum-based materials, its extensive use not only causes a waste of resources, but also brings “white pollution” to the environment. So it has caused widespread concern in society. The incineration and on-site burial of waste plastic film will cause serious air pollution and soil pollution, and the secondary recovery has the shortcomings of low recovery rate, material property degradation and recovery cost too high, so the promotion of the use of all biodegradable materials is undoubtedly an effective way to fundamentally solve the problem of “white pollution”.

At present, our country for full biodegradable film research and development has made remarkable achievements, such as the number published application for a patent for invention CN102702696A with polylactic acid (PLA) and poly(adipic acid/terephthalic acid butyl ester (PBAT) as the main base material, the preparation of the biodegradable film blow molding thickness of 20 microns, the tensile strength of 11˜12.1 MPa, the elongation at break of more than 150%. The invention patent No. CN103589124A also prepared a full biodegradable film with PLA/PBAT, and the tensile strength of the film was up to 61 MPa by adding a composite solvent and mineral filler. The invention patent No. CN102675839A uses PLA, PBAT and polypropyl carbonate (PPC) as the substrate, and the impact strength of the fully biodegradable film is higher than that of the traditional polyethylene film. All the above-mentioned biodegradable films have good comprehensive properties, but they are generally expensive compared with traditional plastic films, which makes their popularization and use encounter great obstacles.

Among many full biodegradable films, the starch-based full biodegradable films have the advantage of price, and starch is a 100% biodegradable material, which is green and renewable. For the invention patent application of CN103435981A, starch and PBAT were selected as the substrate to prepare a biodegradable film with bio-base content up to 30%. The film has good toughness, the elongation at break can reach up to 271%, but due to the low tensile strength, less than 3 MPa, it is difficult to meet the use requirements. However, the full biodegradable material polyglycolic acid (PGA) has a large mechanical strength, its tensile strength is more than 100 MPa, and its price is relatively low compared with other full biodegradable materials. Therefore, PGA, starch and PBAT are combined efficiently, which is expected to produce low cost full biodegradable film with excellent comprehensive performance.

### SUMMARY OF THE INVENTION

### Purpose of the Invention

The invention provides a low cost bio-based full biodegradable film and a preparation method thereof for solving the problem of high cost of the existing biodegradable film and difficult to popularize and apply. The invention takes PGA, starch and PBAT as substrate, reduces the melting temperature of the PGA through plasticizing modification, so as to avoid the serious gelatinization of the starch during high temperature blending; reactive additives are used to solve the problem of interface compatibility between PGA, PBAT and thermoplastic starch (TPS), low cost full biodegradable film materials are prepared by blending modification technology.

### Technical Solution

In order to achieve the above-mentioned purposes, the invention adopts the following technical scheme. A low cost bio-based full degradable film comprises the following materials in mass: 15-25 parts of a polyglycolic acid, 5-35 parts of corn starch, 35-55 parts of poly(butylene adipate-co-terephthalate), 5 parts of a compatilizer, 3.75-12.25 parts of a starch plasticizer, 0.5-0.7 part of citric acid, 0.75-1.25 parts of acetyl tributyl citrate, 0.3-0.5 part of maleic anhydride, 0.2 part of antioxidant 164, and 0.2 part of 2-(2″-hydroxyl-5″-methylphenyl)benzotriazole.

In certain embodiments, the starch plasticizer is one or two of glycerol, glycol, formamide, urea, ethylene bisformamide.

In certain embodiments, the compatilizer is any one of graft copolymerization of butyl acrylate with glycidyl methacrylate , ethylene-acrylic acid copolymer, ethylene-vinyl acetate copolymer.

Another aspect of the present invention is a process for providing low cost bio-based full biodegradable film, the method comprises the following steps:

a) put the polyglycolic acid, maleic anhydride and acetyl tributyl citrate into the parallel double screw extrusion machine, by fusing, cross blending, wind cooling and pelleting, obtain the plasticized and end capping modified polyglycolic acid master batch.

b) put the corn starch and starch plasticizer into a high speed mixer, by heating and high speed agitating, obtain the thermoplastic starch.

c) put the poly(butylene adipate-co-terephthalate), compatilizer, citric acid, antioxidant 164, 2-(2″-hydroxyl-5″-methylphenyl)benzotriazole, the modified polyglycolic acid master batch resulted from step a) into the thermoplastic starch resulted from step b), by heating in high speed mixer and slow speed agitating homogeneously obtain the compound master batch.

d) put the compound master batch resulted from step c) into the parallel twin-screw extruder, by fusing, cross blending, wind cooling and pelleting, obtain the low cost bio-based full degradable blown film resin.

e) put the bio-resin resulted from step d) into the common high pressure PE film blowing machine, obtain the low cost bio-based full degradable film with a thickness of 15 μm and a width of 920 mm.

In certain embodiments, step a) the temperature of sections for 1-7 of the said double screw extrusion machine each is 160° C., 180° C., 230° C., 230° C., 230° C., 230° C., 230° C., and the extrusion head temperature is 220° C.

In certain embodiments, step a) the heating temperature of the high speed mixer is 100° C., with mixer rotating speed of 500 rpm, and blending material for 10 minutes.

In certain embodiments, step c) the heating temperature of the high speed mixer is 100° C., with mixer rotating speed of 200 rpm, and blending material for 4 minutes.

In certain embodiments, step d) the temperature of sections for 1-7 of the said double screw extrusion machine each is 150° C., 170° C., 180° C., 180° C., 180° C., 180° C., 180° C., and the extrusion head temperature is 170° C.

In certain embodiments, step e) the temperature of sections for 1-4 of the said the common high pressure PE film blowing machine each is 150° C., 180° C., 180° C., 180° C.

Beneficial effect: compared with the prior art, the bio-base content of the low cost bio-base full degraded film provided by the present invention can reach more than 30% , the cost is lower, and the tensile strength is higher than that of the traditional PE film, it is of great significance to solve the problem of “white pollution” and promote the popularization and application of all biodegradable materials.

### EXMPLES

The contents of the present invention are further explained by embodiments below, but shall not be construed as limiting the present invention. The modification and replacement of the method, step or condition of the invention without deviating from the spirit and essence of the invention belong to the scope of the invention. If not specified, the technical means used in the embodiments are the conventional means known to the technical personnel in the field.

### Example 1

The low cost bio-based full degradable film comprises the following materials in mass: 15 parts of a polyglycolic acid, 25 parts of corn starch, 55 parts of poly(butylene adipate-co-terephthalate), 1.25 parts of glycerol, 2.5 parts of glycol, 5 parts of graft copolymerization of butyl acrylate with glycidyl methacrylate, 0.5 parts of citric acid, 0.75 parts of acetyl tributyl citrate, 0.3 parts of maleic anhydride, 0.2 parts of antioxidant 164, and 0.2 parts of 2-(2″ -hydroxyl-5″-methylphenyl)benzotriazole.

Preparation of the low cost bio-based full degradable film:

First, the polyglycolic acid, maleic anhydride and acetyl tributyl citrate are mixed evenly and then added to a parallel co-rotating twin-screw extruder for extrusion, set the temperature of sections for 1-7 of extruder to160° C., 180° C., 230° C., 230° C., 230° C., 230° C., 230° C. in turn, and the extrusion head temperature is 220° C., obtain the plasticized and end capping modified PGA master batch.

Then, the corn starch, glycerol and glycol are added to the high speed mixer, set the heating temperature of the high speed mixer at 100° C., rotating speed at 500 rpm and mixing time at 10 minutes, obtain the thermoplastic starch.

And then put the plasticized and end capping modified PGA master batch, poly(butylene adipate-co-terephthalate), graft copolymerization of butyl acrylate with glycidyl methacrylate citric acid, antioxidant 164 and 2-(2″-hydroxyl-5″-methylphenyl)benzotriazole into the prepared the thermoplastic starch, set the heating temperature of the high speed mixer at 100° C., rotating speed at 200 rpm and mixing time at 4 minutes, obtain the mixed master batch.

The mixed master batch is then added to a parallel co-rotating twin-screw extruder for blending extrusion, set the temperature of sections for 1-7 of extruder to150° C., 170° C., 180° C., 180° C., 180° C., 180° C., 180° C. in turn, and the extrusion head temperature is 170° C., obtain the bio-based low cost full degradation blowing film material.

And finally, the bio-based low cost full degradable blowing film material is passed through the common high pressure PE film blowing machine, set the temperature of sections for 1-4 of blowing machine to 150° C., 180° C., 180° C., 180° C. in turn.

Obtain the low cost bio-based full degradable film with a thickness of 15 μm and a width of 920 mm.

### Example 2

The low cost bio-based full degradable film comprises the following materials in mass: 20 parts of a polyglycolic acid, 30 parts of corn starch, 45 parts of poly(butylene adipate-co-terephthalate), 4 parts of formamide, 2 parts of urea, 5 parts of graft copolymerization of butyl acrylate with glycidyl methacrylate, 0.6 parts of citric acid, 1 parts of acetyl tributyl citrate, 0.4 parts of maleic anhydride, 0.2 parts of antioxidant 164, and 0.2 parts of 2-(2″-hydroxyl-5″-methylphenyl)benzotriazole.

Preparation of the low cost bio-based full degradable film:

First, the polyglycolic acid, maleic anhydride and acetyl tributyl citrate are mixed evenly and then added to a parallel co-rotating twin-screw extruder for extrusion, set the temperature of sections for 1-7 of extruder to160° C., 180° C., 230° C., 230° C., 230° C., 230° C., 230° C. in turn, and the extrusion head temperature is 220° C., obtain the plasticized and end capping modified PGA master batch.

Then, the corn starch, formamide and urea are added to the high speed mixer, set the heating temperature of the high speed mixer at 100° C., rotating speed at 500 rpm and mixing time at 10 minutes, obtain the thermoplastic starch.

And then put the plasticized and end capping modified PGA master batch, poly(butylene adipate-co-terephthalate), graft copolymerization of butyl acrylate with glycidyl methacrylate citric acid, antioxidant 164 and 2-(2″-hydroxyl-5″-methylphenyl)benzotriazole into the prepared the thermoplastic starch, set the heating temperature of the high speed mixer at 100° C., rotating speed at 200 rpm and mixing time at 4 minutes, obtain the mixed master batch.

The mixed master batch is then added to a parallel co-rotating twin-screw extruder for blending extrusion, set the temperature of sections for 1-7 of extruder to150° C., 170° C., 180° C., 180° C., 180° C., 180° C., 180° C. in turn, and the extrusion head temperature is 170° C., obtain the bio-based low cost full degradation blowing film material.

And finally, the bio-based low cost full degradable blowing film material is passed through the common high pressure PE film blowing machine, set the temperature of sections for 1-4 of blowing machine to 150° C., 180° C., 180° C., 180° C. in turn.

Obtain the low cost bio-based full degradable film with a thickness of 15 μm and a width of 920 mm.

### Example 3

The low cost bio-based full degradable film comprises the following materials in mass: 25 parts of a polyglycolic acid, 35 parts of corn starch, 35 parts of poly(butylene adipate-co-terephthalate), 12.25 parts of ethylene bisformamide, 5 parts of graft copolymerization of butyl acrylate with glycidyl methacrylate, 0.7 parts of citric acid, 1.25 parts of acetyl tributyl citrate, 0.5 parts of maleic anhydride, 0.2 parts of antioxidant 164, and 0.2 parts of 2-(2″-hydroxyl-5″-methylphenyl)benzotriazole.

Preparation of the low cost bio-based full degradable film:

First, the polyglycolic acid, maleic anhydride and acetyl tributyl citrate are mixed evenly and then added to a parallel co-rotating twin-screw extruder for extrusion, set the temperature of sections for 1-7 of extruder to160° C., 180° C., 230° C., 230° C., 230° C., 230° C., 230° C. in turn, and the extrusion head temperature is 220° C., obtain the plasticized and end capping modified PGA master batch.

Then, the corn starch and ethylene bisformamide are added to the high speed mixer, set the heating temperature of the high speed mixer at 100° C., rotating speed at 500 rpm and mixing time at 10 minutes, obtain the thermoplastic starch.

And then put the plasticized and end capping modified PGA master batch, poly(butylene adipate-co-terephthalate), graft copolymerization of butyl acrylate with glycidyl methacrylate citric acid, antioxidant 164 and 2-(2″-hydroxyl-5″-methylphenyl)benzotriazole into the prepared the thermoplastic starch, set the heating temperature of the high speed mixer at 100° C., rotating speed at 200 rpm and mixing time at 4 minutes, obtain the mixed master batch.

The mixed master batch is then added to a parallel co-rotating twin-screw extruder for blending extrusion, set the temperature of sections for 1-7 of extruder to150° C., 170° C., 180° C., 180° C., 180° C., 180° C., 180° C. in turn, and the extrusion head temperature is 170° C., obtain the bio-based low cost full degradable blowing film material.

And finally, the bio-based low cost full degradable blowing film material is passed through the common high pressure PE film blowing machine, set the temperature of sections for 1-4 of blowing machine to 150° C., 180° C., 180° C., 180° C. in turn.

Obtain the low cost bio-based full degradable film with a thickness of 15 μm and a width of 920 mm.

### Example 4

The low cost bio-based full degradable film comprises the following materials in mass: 25 parts of a polyglycolic acid, 35 parts of corn starch, 35 parts of poly(butylene adipate-co-terephthalate), 12.25 parts of ethylene bisformamide, 5 parts of a ethylene-acrylic acid copolymer,0.7 parts of citric acid, 1.25 parts of acetyl tributyl citrate, 0.5 parts of maleic anhydride, 0.2 parts of antioxidant 164, and 0.2 parts of 2-(2″-hydroxyl-5″-methylphenyl)benzotriazole.

Preparation of the low cost bio-based full degradable film:

First, the polyglycolic acid, maleic anhydride and acetyl tributyl citrate are mixed evenly and then added to a parallel co-rotating twin-screw extruder for extrusion, set the temperature of sections for 1-7 of extruder to160° C., 180° C., 230° C., 230° C., 230° C., 230° C., 230° C. in turn, and the extrusion head temperature is 220° C., obtain the plasticized and end capping modified PGA master batch.

Then, the corn starch and a ethylene bisformamide are added to the high speed mixer, set the heating temperature of the high speed mixer at 100° C., rotating speed at 500 rpm and mixing time at 10 minutes, obtain the thermoplastic starch.

And then put the plasticized and end capping modified PGA master batch, poly(butylene adipate-co-terephthalate), ethylene-acrylic acid copolymer, citric acid, antioxidant 164 and 2-(2″-hydroxyl-5″-methylphenyl)benzotriazole into the prepared the thermoplastic starch, set the heating temperature of the high speed mixer at 100° C., rotating speed at 200 rpm and mixing time at 4 minutes, obtain the mixed master batch.

The mixed master batch is then added to a parallel co-rotating twin-screw extruder for blending extrusion, set the temperature of sections for 1-7 of extruder to150° C., 170° C., 180° C., 180° C., 180° C., 180° C., 180° C. in turn, and the extrusion head temperature is 170° C., obtain the bio-based low cost full degradable blowing film material.

And finally, the bio-based low cost full degradable blowing film material is passed through the common high pressure PE film blowing machine, set the temperature of sections for 1-4 of blowing machine to 150° C., 180° C., 180° C., 180° C. in turn.

Obtain the low cost bio-based full degradable film with a thickness of 15 μm and a width of 920 mm.

### Example 5

The low cost bio-based full degradable film comprises the following materials in mass: 25 parts of a polyglycolic acid, 35 parts of corn starch, 35 parts of poly(butylene adipate-co-terephthalate), 12.25 parts of ethylene bisformamide, 5 parts of ethylene-vinyl acetate copolymer,0.7 parts of citric acid, 1.25 parts of acetyl tributyl citrate, 0.5 parts of maleic anhydride, 0.2 parts of antioxidant 164, and 0.2 parts of 2-(2″-hydroxyl-5″-methylphenyl)benzotriazole.

Preparation of the low cost bio-based full degradable film:

First, the polyglycolic acid, maleic anhydride and acetyl tributyl citrate are mixed evenly and then added to a parallel co-rotating twin-screw extruder for extrusion, set the temperature of sections for 1-7 of extruder to160° C., 180° C., 230° C., 230° C., 230° C., 230° C., 230° C. in turn, and the extrusion head temperature is 220° C., obtain the plasticized and end capping modified PGA master batch.

Then, the corn starch and a ethylene bisformamide are added to the high speed mixer, set the heating temperature of the high speed mixer at 100° C., rotating speed at 500 rpm and mixing time at 10 minutes, obtain the thermoplastic starch.

And then put the plasticized and end capping modified PGA master batch, poly(butylene adipate-co-terephthalate), ethylene-acrylic acid copolymer, citric acid, antioxidant 164 and 2-(2″-hydroxyl-5″-methylphenyl)benzotriazole into the prepared the thermoplastic starch, set the heating temperature of the high speed mixer at 100° C., rotating speed at 200 rpm and mixing time at 4 minutes, obtain the mixed master batch.

The mixed master batch is then added to a parallel co-rotating twin-screw extruder for blending extrusion, set the temperature of sections for 1-7 of extruder to 150° C., 170° C., 180° C., 180° C., 180° C., 180° C., 180° C. in turn, and the extrusion head temperature is 170° C., obtain the bio-based low cost full degradation blowing film material.

And finally, the bio-based low-cost full degradable blowing film material is passed through the common high pressure PE film blowing machine, set the temperature of sections for 1-4 of blowing machine to 150° C., 180° C., 180° C., 180° C. in turn.

Obtain the low cost bio-based full degradable film with a thickness of 15 μm and a width of 920 mm.

### Comparative Example 1

The full biodegradable film comprises the following materials in mass: 25 parts of corn starch, 75 parts of poly(butylene adipate-co-terephthalate), 1.25 parts of glycerol, 2.5 parts of glycol, 5 parts of graft copolymerization of butyl acrylate with glycidyl methacrylate, 0.5 parts of citric acid, 0.2 parts of antioxidant 164, and 0.2 parts of 2-(2″-hydroxyl-5″-methylphenyl)benzotriazole.

Preparation of the full biodegradable film:

First, the corn starch, glycerol and glycol are added to the high speed mixer, set the heating temperature of the high speed mixer at 100° C., rotating speed at 500 rpm and mixing time at 10 minutes, obtain the thermoplastic starch.

And then put the poly(butylene adipate-co-terephthalate), graft copolymerization of butyl acrylate with glycidyl methacrylate, citric acid, antioxidant 164 and 2-(2″-hydroxyl-5″-methylphenyl)benzotriazole into the prepared the thermoplastic starch, set the heating temperature of the high speed mixer at 100° C., rotating speed at 200 rpm and mixing time at 4 minutes, obtain the mixed master batch.

The mixed master batch is then added to a parallel co-rotating twin-screw extruder for blending extrusion, set the temperature of sections for 1-7 of extruder to150° C., 170° C., 180° C., 180° C., 180° C., 180° C., 180° C. in turn, and the extrusion head temperature is 170° C., obtain the full biodegradable blowing film material.

And finally, the bio-based blowing film material is passed through the common high pressure PE film blowing machine, set the temperature of sections for 1-4 of blowing machine to 150° C., 180° C., 180° C., 180° C. in turn.

Obtain the full biodegradable film with a thickness of 15 μm and a width of 920 mm.

### Comparative Example 2

The low density polyethylene (LDPE) film grade FB 3000 made by LG Company is passed through the common PE film blowing machine, set the temperature of each section of blowing machine to 150° C.

Obtain the thin film with a thickness of 15 p.m and a width of 920 mm.

### Example 6

The purpose of this embodiment is to evaluate the mechanical properties of the films prepared in embodiments 1-5 and in comparative example 1 and 2, according to GB/T1040.3-2006, the relevant tests are carried out on the universal tensile testing machine (CMT-4304, Shenzhen Xinsansi Co., Ltd.). The test speed is 50 mm/Min. The test results are detailed in Table 1.

TABLE 1
Mechanical properties of different films

| | | | | Angle |
|---|---|---|---|---|
| | | Tensile | Elongation | tear strength/ |
| Film type | | strength/MPa | at break/% | (N · mm−1) |
| Example 1 | longitudinal | 25.55 ± 2.11 | 297.48 ± 19.31 | 123.46 ± 8.77 |
| | lateral | 23.49 ± 1.02 | 248.96 ± 33.47 | 128.55 ± 6.82 |
| Example 2 | longitudinal | 30.06 ± 4.98 | 233.21 ± 28.94 | 108.89 ± 13.99 |
| | lateral | 24.92 ± 2.06 | 227.46 ± 12.31 | 100.31 ± 9.66 |
| Example 3 | longitudinal | 38.87 ± 4.66 | 159.71 ± 17.88 | 114.41 ± 3.22 |
| | lateral | 32.94 ± 5.72 | 144.36 ± 27.55 | 98.66 ± 6.36 |
| Example 4 | longitudinal | 30.27 ± 1.78 | 106.74 ± 18.84 | 92.31 ± 11.29 |
| | lateral | 28.86 ± 6.87 | 96.55 ± 25.67 | 88.66 ± 7.82 |
| Example 5 | longitudinal | 28.71 ± 3.66 | 135.39 ± 17.79 | 108.75 ± 21.15 |
| | lateral | 26.54 ± 3.76 | 129.96 ± 15.83 | 94.00 ± 3.32 |
| Compar- | longitudinal | 19.57 ± 1.99 | 357.21 ± 37.87 | 127.26 ± 12.17 |
| ative | lateral | 17.87 ± 4.87 | 377.26 ± 23.68 | 119.83 ± 3.42 |
| Example 1 | | | | |
| Compar- | longitudinal | 22.37 ± 1.76 | 223.76 ± 12.21 | 101.28 ± 6.32 |
| ative | lateral | 20.58 ± 3.19 | 207.19 ± 21.18 | 96.43 ± 3.33 |
| Example 2 | | | | |

From the test data of Examples 1˜3, it is observed that along with the increase of PGA content of in the formulation system, the tensile strength of film increase continually, and elongation at break is decrease gradually. According to the test data of Examples 3˜5, the graft copolymerization of butyl acrylate with glycidyl methacrylate has the best compatibilization effect on PGA, TPS and PBAT within three compatiblizing agents.

Compared with the biodegradable film without addition of PGA and the conventional PE film, it can be seen from the test data of the embodiment 1˜5 and the comparative examples of 1˜2, the low cost bio-based full degradable film has greater tensile strength.

In conclusion the invention takes PGA, starch and PBAT as base materials, reduces the melting temperature of the PGA through plasticizing modification, and avoids the serious slication of the starch when it is mixed at high temperature, the invention takes PGA, starch and PBAT as substrate, reduces the melting temperature of the PGA through plasticizing modification, so as to avoid the serious gelatinization of the starch during high temperature blending; reactive additives are used to solve the problem of interface compatibility between PGA, PBAT and thermoplastic starch (TPS), low cost full biodegradable film materials are prepared by blending modification technology, and furthermore, the bio-base content of the low cost bio-base full degraded film provided by the present invention can reach more than 30%, the cost is lower, and the tensile strength is higher than that of the traditional PE film, it is of great significance to solve the problem of “white pollution” and promote the popularization and application of all biodegradable materials.

The PGA used in the invention is produced by our company, other ingredients such as PBAT, maleic anhydride, corn starch, starch plasticizer, compatilizer, citric acid, acetyl tributyl citrate, antioxidant 164, 2-(2″-hydroxyl-5″-methylphenyl)benzotriazole, etc. are purchased directly from the market.

The above description is only a description of a better embodiment of the invention and is not any limitation of the scope of the invention. Any alteration or modification made by an ordinary technician who is familiar with the field in accordance with the technical content disclosed above shall be deemed to be an equivalent effective embodiment and shall fall under the protection of the technical scheme of the present invention.

What is claimed is:

1. A low cost bio-based full degradable film, comprising the following materials in mass: 15-25 parts of a polyglycolic acid, 5-35 parts of corn starch, 35-55 parts of poly(butylene adipate-co-terephthalate), 5 parts of a compatilizer, 3.75-12.25 parts of a starch plasticizer, 0.5-0.7 part of citric acid, 0.75-1.25 parts of acetyl tributyl citrate, 0.3-0.5 part of maleic anhydride, 0.2 part of antioxidant 164, and 0.2 part of 2-(2″ -hydroxyl-5″-methylphenyl)benzotriazole.

2. The low cost bio-based full degradable film of claim 1, wherein the starch plasticizer is any one of or two of: glycerol, glycol, formamide, urea, an ethylene bisformamide.

3. The low cost bio-based full degradable film of claim 1, wherein the compatilizer is a graft copolymerization of butyl acrylate with glycidyl methacrylate , a ethylene-acrylic acid copolymer, or a ethylene-vinyl acetate copolymer.

4. A method for preparing the low cost bio-based full degradable film, the method comprising the steps of:
a) put the polyglycolic acid, maleic anhydride and acetyl tributyl citrate into the parallel double screw extrusion machine, by fusing, cross blending, wind cooling and pelleting, obtain the plasticized and end capping modified polyglycolic acid master batch.
b) put the corn starch and starch plasticizer into a high speed mixer, by heating and high speed agitating, obtain the thermoplastic starch.
c) put the poly(butylene adipate-co-terephthalate), compatilizer, citric acid, antioxidant 164, 2-(2″-hydroxyl-5″-methylphenyl)benzotriazole, the modified polyglycolic acid master batch resulted from step a) into the thermoplastic starch resulted from step b), by heating in high speed mixer and slow speed agitating homogeneously obtain the compound master batch.
d) put the compound master batch resulted from step c) into the parallel twin-screw extruder, by fusing, cross blending, wind cooling and pelleting, obtain the low cost bio-based full degradable blown film resin.
e) put the bio-resin resulted from step d) into the common high pressure PE film blowing machine, obtain the low cost bio-based full degradable film with a thickness of 15 μm and a width of 920 mm.

5. The method of claim 4, wherein the temperature of sections for 1-7 of the said double screw extrusion machine each is 160° C., 180° C., 230° C., 230° C., 230° C., 230° C., 230° C., and the extrusion head temperature is 220° C.

6. The method of claim 4, wherein the heating temperature of the high speed mixer is 100° C., with mixer rotating speed of 500 rpm, and blending material for 10 minutes.

7. The method of claim 4, wherein the heating temperature of the high speed mixer is 100° C., with mixer rotating speed of 200 rpm, and blending material for 4 minutes.

8. The method of claim 4, wherein the temperature of sections for 1-7 of the said double screw extrusion machine each is 150 , 170° C., 180° C., 180° C., 180° C., 180° C., 180° C., and the extrusion head temperature is 170° C. within step d).

9. The method of claim 4, wherein the temperature of sections for 1-4 of the said the common high pressure PE film blowing machine each is 150° C., 180° C., 180° C., 180° C. within step e).
